(19) United States
(12) Patent Application Publication
(10) Pub. No.: US 2023/0175833 A1
(43) Pub. Date: Jun. 8, 2023

(54) Method and apparatus for measuring objects

(71) Applicant: SICK AG, Waldkirch (DE)

(72) Inventors: Günter HIRT, Steinach (DE); Lukas HAUSER, Freiburg im Breisgau (DE); Clemens HAUSER, Emmendingen (DE)

(21) Appl. No.: 17/993,250

(22) Filed: Nov. 23, 2022

(30) Foreign Application Priority Data
Nov. 25, 2021 (DE) 102021130870.4

(51) Int. Cl. G01B 11/04

(52) U.S. Cl. CPC G01B 11/043

(57) ABSTRACT

A method of measuring objects that are conveyed in a conveying direction comprises the steps that
(i) a first object edge of a conveyed object is detected at a first measurement position by means of a first optoelectronic sensor,
(ii) the first object edge or a second object edge of the object is detected at a second measurement position, which is spaced apart from the first measurement position in the conveying direction, by means of a second optoelectronic sensor that is spatially resolving at least in the conveying direction,
(iii) a time difference between the detection of the first object edge at the first measurement position and the detection of the object edge detected in step (ii) at the second measurement position is determined,
(iv) a transit time is determined in which the object edge detected in step (ii) moves through a predetermined measurement path,
(v) the object speed is determined based on the transit time and a length of the measurement path, and
(vi) the length of the object is determined based on the determined time difference and the determined object speed.

The invention relates to a method and an apparatus for measuring objects that are conveyed in a conveying direction by means of an object conveyor.

In various areas of industry, it is desired to measure conveyed objects such as workpieces, intermediate products or end products without interrupting the conveying process. The object conveyors used for conveying are often operated at relatively high speeds, e.g. several meters per second. Furthermore, harsh and changing environmental conditions often exist at object conveyors. Similarly, the conveyed objects can have different surfaces. Furthermore, a correct position of the objects cannot always be guaranteed. Accordingly, it is difficult in practice to perform a measurement of objects with a high measurement accuracy during the conveying process.

It is an object of the invention to enable a more precise and more reliable measurement of conveyed objects with simple means.

The object is satisfied by a method having the features of claim 1.

In a method in accordance with the invention, provision is made that
(i) a first object edge of a conveyed object is detected at a first measurement position by means of a first optoelectronic sensor,
(ii) the first object edge or a second object edge of the conveyed object is detected at a second measurement position, which is spaced apart from the first measurement position in the conveying direction, by means of a second optoelectronic sensor that is spatially resolving at least in the conveying direction,
(iii) a time difference between the detection of the first object edge at the first measurement position and the detection of the object edge detected in step (ii) at the second measurement position is determined,
(iv) a transit time is determined in which the object edge detected in step (ii) moves through a predetermined measurement path of the second optoelectronic sensor extending in the conveying direction,
(v) the object speed at which the conveyed object moves in the conveying direction is determined based on the transit time and a length of the measurement path, and
(vi) the length of the object is determined based on the determined time difference and the determined object speed.

An optoelectronic sensor spatially resolving in the conveying direction is therefore used to determine the object speed. It is then not necessary to derive the object speed by means of a higher-ranking control device from detection times of different individual sensors. Based on the object edge running through the measurement path, the object speed can be determined easily and quickly. It has been found that a precise length measurement is also possible under difficult conditions by means of a method in accordance with the invention. A method in accordance with the invention is particularly suitable for objects having clearly recognizable object edges such as plates, blocks, pipes, or containers. The measurement path can be the complete field of view of the spatially resolving optoelectronic sensor, for example, the complete line length of a line sensor oriented in the conveying direction.

In accordance with an embodiment of the invention, in step (i), a rear edge of the conveyed object is detected at the first measurement position as the first object edge and/or, in step (ii), a front edge of the conveyed object is detected at the second measurement position as the first object edge. In particular for comparatively long objects, the magnitude of the time difference to be determined in step (iii) can thereby be minimized, which is favorable in terms of the measurement accuracy. The term “front edge” is to be understood as an object edge running ahead in the conveying direction, while the term “rear edge” is to be understood as an object edge trailing in the conveying direction. The “first object edge” mentioned in step (i) is therefore not necessarily the object edge running ahead in the conveying direction.

The determination of the time difference in step (iii) can comprise a trigger signal being output by the first optoelectronic sensor to the second optoelectronic sensor on the detection of the first object edge at the first measurement position, said trigger signal initiating an internal clock of the second optoelectronic sensor. The internal clock can subsequently be used as a time reference system for the entire measurement. The measurement is thus independent of additional time information of external apparatus. The synchronization of the individual system components is in particular facilitated. A particular advantage is that many optoelectronic sensors are anyway equipped with a relatively high-frequency internal clock, for example in the megahertz range, that can additionally be used for a precise time measurement. The internal clock can be defined by a quartz component on a chip of the second optoelectronic sensor.

The time difference can be determined in a simple manner based on the cycles of the clock that have elapsed until the detection of the object edge detected in step (ii) at the second measurement position. With an internal clock in the megahertz range, a time resolution in the microsecond range results.

A further embodiment of the invention provides that, in step (vi), the length of the object is further determined based on the distance between the first measurement position and the second measurement position. This distance is generally predefined on the basis of the installation positions of the optoelectronic sensors.

In the case that, in step (i), a rear edge of the conveyed object is detected at the first measurement position and, in step (ii), a front edge of the conveyed object is detected at the second measurement position, the length of the object can be determined in that the product of the time difference determined in step (iii) and the object speed determined in step (v) is subtracted from the distance between the first measurement position and the second measurement position. The distance between the first measurement position and the second measurement position can be related to the conveying direction.

Provision can be made that, for the calibration, an object of a known length is conveyed and the distance between the first measurement position and the second measurement position is determined or adapted based on the known length. The requirements for the assembly accuracy can thereby be reduced. For example, a comparison of the known length with the length determined in step (vi) can be made for the calibration. The object of a known length can be a grid metal sheet or the like. In general, a calibration could also be carried out on the basis of a measurement of an object by an alternative measurement system.

In accordance with a specific embodiment, in step (i), the first object edge is detected at the first measurement position by means of a light barrier. This is not only simple and cost-effective, but also robust with respect to harsh and changing environmental conditions. A light barrier having a beam diameter adapted to the object is advantageous here with respect to the measurement accuracy. In general, in step (i), the first object edge could also be detected at the first measurement position by means of a line sensor or a camera.

The object edge to be detected in step (ii) can be detected at the second measurement position by means of a camera. In contrast, an advantageous embodiment provides that the object edge to be detected in step (ii) is detected at the second measurement position by means of a line sensor. A line sensor is usually easier to assemble and to configure and less sensitive with respect to external light.

Provision can be made that position markings of a reference scale, which is separate from the base frame, are detected by means of at least one further optoelectronic sensor, which is fastened together with the first and the second optoelectronic sensor to a base frame of the object conveyor, and are considered in the determination of the length of the object. In this way, it is possible to compensate linear expansions of components of the object conveyor and thus to increase the measurement accuracy. The further optoelectronic sensor can, for example, be a line sensor. At least two further optoelectronic sensors are preferably provided for detecting position markings of the reference scale and are spaced apart from one another in the conveying direction.

The reference scale can comprise a bar which extends in the conveying direction, which is composed of a material having a low coefficient of expansion, and to which the position markings are applied. In accordance with a specific embodiment, the reference scale is made of quartz glass that has a particularly low thermal expansion.

The reference scale can be floatingly supported so that it is unaffected by linear expansions of the holder components. The reference scale can in particular be displaceably supported in and/or against the conveying direction. An abutment can be provided to limit the displaceability to one direction. For example, the reference scale can be supported by supports that are fastened to the ground or to the base frame of the object conveyor.

To facilitate the measurement of objects of different lengths, at least one further optoelectronic sensor can be provided that is spatially resolving at least in the conveying direction and that is arranged in front of or behind the second optoelectronic sensor in the conveying direction.

The object indicated above is also satisfied by a method of measuring objects that are conveyed in a conveying direction by means of an object conveyor, in which
(a) an object edge of a conveyed object is detected at an inspection position by means of an optoelectronic sensor,
(b) on the detection of the object edge at the inspection position, a trigger signal is output to at least two further optoelectronic sensors that are spatially resolving at least in the conveying direction and that are arranged spaced apart from one another at least transversely to the conveying direction,
(c) on or after the reception of the trigger signal, sensor data of the optoelectronic sensors that are spatially resolving at least in the conveying direction are read out,
(d) respective positions of the object edge are determined based on the read-out sensor data, and
(e) an orientation of the object edge relative to the conveying direction is determined based on the determined positions of the object edge.

Due to the trigger signal, all the inputs can start in a synchronized manner. The sensor data of the at least two spatially resolving sensors can therefore be read out precisely when the object edge is located in the associated fields of view. The determination of two edge positions at different points along the edge course makes it possible to determine the orientation of the object edge and thus of the entire object. A slanted position and/or a shape deviation of a conveyed object can in particular be recognized and considered during the measurement.

The determination of the orientation of the object edge can be advantageously combined with the determination of the length of the object in a common measurement process.

In step (e), the orientation of the object edge relative to the conveying direction can be determined by means of a linear regression. Thus, selective deviations from the predefined edge geometry can be compensated by an averaging.

An embodiment of the invention provides that, in step (b), the trigger signal is further output to an optoelectronic sensor that is spatially resolving at least transversely to the conveying direction and that is arranged in the region of a side edge of the conveyed object, wherein the position of the side edge is determined by means of the optoelectronic sensor that is spatially resolving at least transversely to the conveying direction and an orientation and/or a shape of the object is/are determined based on the position of the side edge. In addition to the orientation of the front edge or rear edge, the orientation of the side edge of the object can thereby also be determined. Thus, a distinction between position deviations and shape deviations is also possible. The determination of the position of the side edge can take place during the conveying of the object through the detection zone of the optoelectronic sensor that is spatially resolving at least transversely to the conveying direction so that selective deviations in the linearity of the side edge can also be recognized.

The invention also relates to an apparatus for measuring objects that are conveyed in a conveying direction by means of an object conveyor, said apparatus comprising a first optoelectronic sensor, a second optoelectronic sensor that is spatially resolving at least in the conveying direction, and an electronic control device that is in signal connection with the first optoelectronic sensor and the second optoelectronic sensor.

In accordance with the invention, the apparatus is configured to carry out a method designed as described above.

At least one reflector can, with respect to the conveyed object, be arranged opposite the first optoelectronic sensor and/or the second optoelectronic sensor at the object conveyor. A contrast enhancement is hereby achieved and the robustness of the apparatus with respect to contamination and the like is increased. Together with the associated optoelectronic sensor, the reflector can form a reflection light barrier.

The first optoelectronic sensor and the second optoelectronic sensor can have respective optical axes that are oriented obliquely upwardly or obliquely downwardly. This improves the measurement accuracy since only the upper side or the lower side of the object edge is detected. In the present text, obliquely upwardly or obliquely downwardly means that the respective optical axis is neither oriented exactly vertically nor exactly horizontally.

The apparatus can further comprise:
at least one further optoelectronic sensor that is spatially resolving at least in the conveying direction and that is spaced apart from the second
optoelectronic sensor in the conveying direction, and
at least two optoelectronic sensors that are spatially resolving at least transversely to the conveying direction and that are spaced apart from one another transversely to the conveying direction.

With such an arrangement, all the edges of a plate-shaped object can be measured.

Further developments of the invention can also be seen from the dependent claims, from the description, and from the enclosed drawings.

The invention will be described in the following by way of example with reference to the drawings.

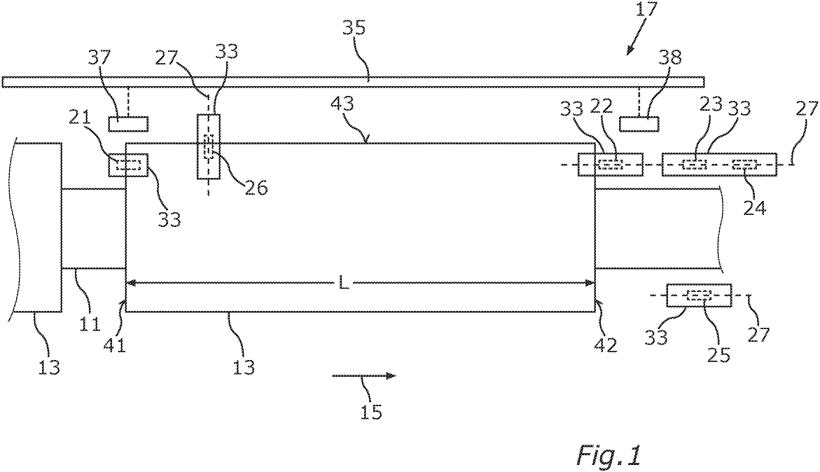

FIG. 1 is a plan view of an apparatus in accordance with the invention for measuring objects that is configured to carry out a method in accordance with the invention;

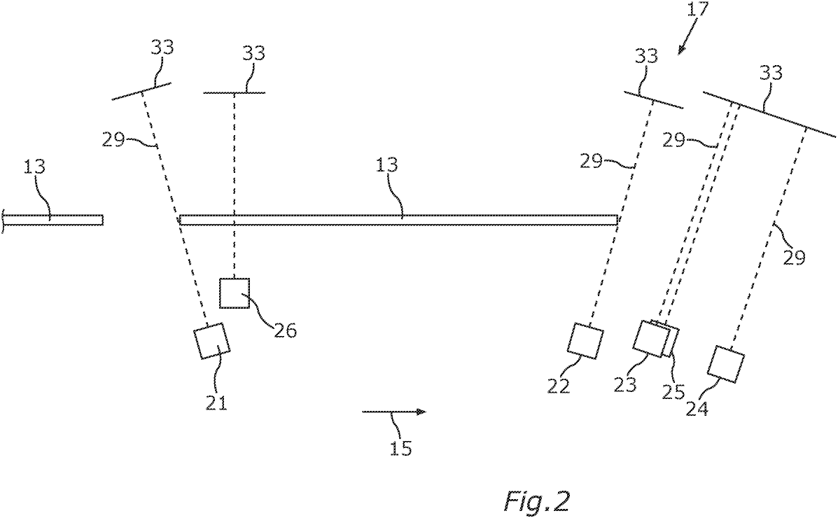

FIG. 2 shows the apparatus in accordance with FIG. 1 in a part view from the side;

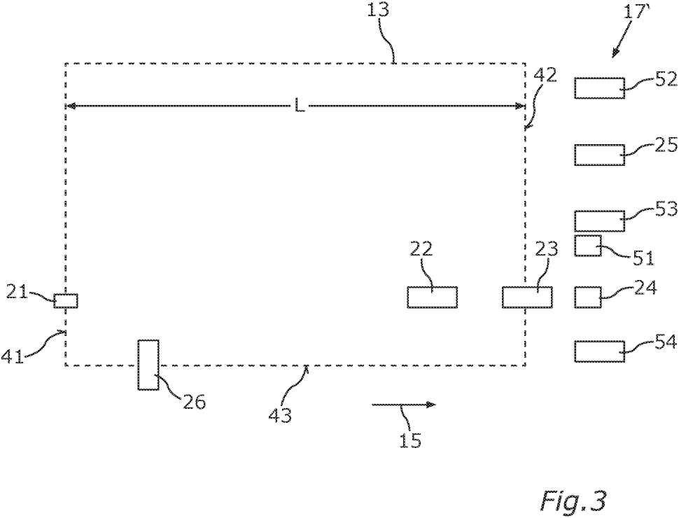

FIG. 3 shows in simplified form an apparatus for measuring objects that is designed in accordance with a further embodiment of the invention and that is configured to carry out a method designed in accordance with a further embodiment of the invention; and

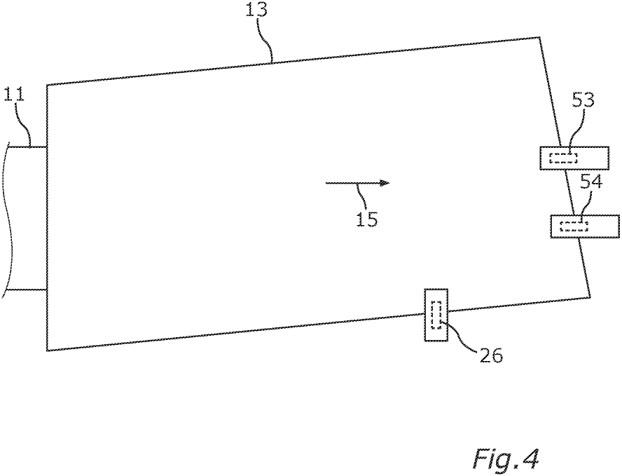

FIG. 4 shows the measurement of an object deviating from an ideal shape by means of the apparatus shown in FIG. 3.

An object conveyor 11 is schematically shown in FIG. 1 by means of which a stream of consecutive objects 13, here for example plates several meters long, is conveyed in a conveying direction 15. Depending on the application, the object conveyor 11 can e.g. be a roller conveyor, a chain conveyor, or a belt conveyor. An object measurement apparatus 17 provided at the object conveyor 11 serves to determine the length of the objects 13 during the conveying, as will be explained in more detail below.

The object measurement apparatus 17 comprises a plurality of optoelectronic sensors, namely a trigger sensor 21 designed as a light barrier, four front edge sensors 22, 23, 24, 25 designed as line sensors, and a side edge sensor 26 designed as a line sensor. A line sensor has an elongated light-sensitive region.

For example, a line sensor can comprise a photodiode line or a one-dimensional or two-dimensional CCD array or CMOS array. A line sensor could also be formed on the basis of a PSD (position sensitive device).

The trigger sensor 21, the front edge sensors 22, 23, 24, 25, and the side edge sensor 26 are each attached to a base frame, not shown, of the object conveyor 11 such that the objects 13 are conveyed through the fields of view of the sensors. As shown, the front edge sensors 22, 23, 24, 25 and the side edge sensor 26 are spaced apart from the trigger sensor 21 to the front in the conveying direction 15. Furthermore, the line axes 27 of the front edge sensors 22, 23, 24, 25 extend in the conveying direction 15 in the plan view, while the line axis 27 of the side edge sensor 26 extends transversely to the conveying direction 15. The front edge sensor 25 located at the bottom in the image is spaced apart from the other front edge sensors 22, 23, 24 transversely to the conveying direction 15.

As can be seen in FIG. 2, the optical axes 29 of the trigger sensor 21 and of the front edge sensors 22, 23, 24, 25 are not oriented exactly vertically, but rather slightly obliquely, for example, with an angular deviation of 5° to 20° to the vertical. Only the lower side of the objects 13 is thereby always detected by the sensors. For a contrast enhancement, respective reflectors 33, which are fastened to the base frame of the object conveyor 11 or to a part of the building, are associated in the manner of a reflection light barrier with the trigger sensor 21, the front edge sensors 22, 23, 24, 25, and the side edge sensor 26.

The object measurement apparatus 17 further comprises a bar 35 which is composed of quartz glass and to which position markings, not shown, are applied. The bar 35 serves as a reference scale and is floatingly supported separately from the base frame of the object conveyor 11. Two reference sensors 37, 38 designed as line sensors are fastened to the base frame of the object conveyor 11 such that they can detect the position markings of the bar 35.

An electronic control device, not shown, of the object measurement apparatus 17 is in signal connection with the trigger sensor 21, the front edge sensors 22, 23, 24, 25, the side edge sensor 26, and the reference sensors 37, 38.

When the rear edge 41 of an object 13 is detected by the trigger sensor 21 during the operation of the object conveyor 11, the trigger sensor 21 outputs a trigger signal to the front edge sensors 22, 23, 24, 25. Said front edge sensors 22, 23, 24, 25 then each start their internal clock. In particular, they each set their reference system to the trigger time and all the measurements subsequently relate to the respective clock. Depending on which nominal length the object 13 has, the front edge sensor 22 at the rear in the conveying direction 15, the front edge sensor 24 at the front in the conveying direction 15, or the front edge sensor 23 located therebetween are used to detect the front edge 42 of the object 13. The line start or the line center of the respective front edge sensor 22, 23, 24 can be selected as the reference point for the detection of the front edge 42.

Based on the internal clock, a time difference between the detection of the rear edge 41 by the trigger sensor 21 and the detection of the front edge 42 by the respective front edge sensor 22, 23, 24 is determined by means of the electronic control device. This can take place in a simple manner by counting the clock cycles. Furthermore, the transit time in which the front edge 42 moves through a predetermined measurement path, e.g. through the entire field of view of the front edge sensor 22, 23, 24, is determined by means of the respective front edge sensor. By dividing the known length of the measurement path by the transit time, the electronic control unit determines the object speed at which the conveyed object 13 moves in the conveying direction 15.

Based on the determined time difference and the determined object speed as well as the known distance between the detection positions, the length L of the object 13, i.e. its extent in the conveying direction 15, is then determined. Specifically, the length L results by subtracting the product of the time difference and the object speed from the distance between the detection positions.

In FIG. 1, it can be seen that two of the front edge sensors 23, 25 have substantially the same distance from the trigger sensor 21 in the conveying direction 15 and are spaced apart from one another transversely to the conveying direction 15 so that they can simultaneously detect the position of the front edge 42 at different points along its course. A possible slanted position of the front edge 42 can thereby be recognized. A possible slanted position of the side edge 43 of the object 13 can, in contrast, be determined by means of the side edge sensor 26 oriented transversely to the conveying direction 15. In a slanted position, the position of the side edge 43 namely changes during its passage.

To prevent possible measurement distortions due to a thermal expansion or a contraction of the apparatus components, the position markings of the bar 35 are detected by means of the reference sensors 37, 38 and are offset against the determined length L.

A calibration of the object measurement apparatus 17 can be performed in that an object 13 of a known length, for example a grid metal sheet, is conveyed by means of the object conveyor 11 and the calculation is adapted accordingly.

The front edge sensors 22, 23, 24, 25, the side edge sensor 26, and the reference sensors 37, 38 could generally also be designed as cameras. However, line sensors are usually less expensive, easier to configure, and less sensitive with respect to external light.

A further embodiment of an object measurement apparatus 17′ in accordance with the invention is shown in FIG. 3. It preferably comprises the same components provided for determining the length L of the object 13 as the object measurement apparatus 17 shown in FIG. 2, in particular a trigger sensor 21 designed as a light barrier, four front edge sensors 22, 23, 24, 25 designed as line sensors, and a side edge sensor 26 designed as a line sensor. In addition, the object measurement apparatus 17′ shown in FIG. 3, however, comprises a further trigger sensor 51 designed as a light barrier as well as three orientation sensors 52, 53, 54 that are arranged at the same height as the further trigger sensor 51 in the conveying direction 15 and that are designed as line sensors. The further trigger sensor 51, just like the orientation sensors 52, 53, 54, is spaced apart to the front from the other trigger sensor 21 in the conveying direction 15.

To measure an object 13, the rear edge 41 of the object 13 is detected by the trigger sensor 21. As soon as the detection has taken place, a trigger signal is output to the further trigger sensor 52 to provide a common reference system for the length measurement and for an alignment measurement, wherein, if applicable, a response time or a dead time is to be considered. Specifically, the output of the trigger sensor 21 can be fed to the input of the further trigger sensor 51.

Furthermore, the further trigger sensor 51 outputs a trigger signal at least to the orientation sensors 52, 53, 54 as soon as it detects the front edge 42. At this point in time, the front edge 42 is located in the field of view of all the orientation sensors 52, 53, 54. On or after the reception of the trigger signal from the further trigger sensor 51, sensor data of the orientation sensors 52, 53, 54 are read out. Respective positions of the front edge 42 of the object 13 are determined based on the sensor data read out. The orientation of the front edge 42 relative to the conveying direction 15 is determined based on the determined positions of the front edge 42. Specifically, the angle which the front edge 42 adopts with respect to the conveying direction 15 or to a reference line extending at a right angle thereto is determined by the electronic control device. Here, a linear regression of the position data of the orientation sensors 52, 53, 54 can be performed to compensate shape deviations of the front edge 42. However, the type of the shape deviation can also be determined. Due to the orientation sensors 52, 53, 54 spaced apart from one another transversely to the conveying direction 15, objects 13 of different widths can furthermore be measured.

The trigger signal is further output to the side edge sensor 26 and optionally to a further sensor of the oppositely disposed side. On or after the reception of the trigger signal, the position of the side edge 43 is determined. The orientation of the side edge 43 is determined based on the change in the position of the side edge 43 during the passage of the object 13. Since both the orientation of the front edge 42 and the orientation of the side edge 43 are known, a distinction can be made between a slanted position of an exactly rectangular object 13 and an object 13 that is not exactly of a rectangular shape as shown in FIG. 4. The principle of edge detection can also be applied to the rear edge 41 with further sensors.

In the embodiment shown in FIG. 3, the determination of the length L of the object 13 in another respect takes place just as described above with reference to FIGS. 1 and 2.

The invention in particular unfolds its advantages during the conveying of plates, but it can also be advantageously used for blocks, rollers, pipes, containers and similar conveyed goods.

Reference numeral list:

| | |
|---|---|
| 11 13 15 17, 17′ 21 22 23 24 25 26 27 29 33 35 37 38 41 42 43 51 52 53 54 L | object conveyor object conveying direction object measurement apparatus trigger sensor front edge sensor front edge sensor front edge sensor side edge sensor side edge sensor line axis optical axis reflector bar reference sensor reference sensor rear edge front edge side edge trigger sensor orientation sensor orientation sensor orientation sensor length |

1. A method of measuring objects that are conveyed in a conveying direction by means of an object conveyor, wherein
(i) a first object edge of a conveyed object is detected at a first measurement position by means of a first optoelectronic sensor,
(ii) the first object edge or a second object edge of the conveyed object is detected at a second measurement position by means of a second optoelectronic sensor that is spatially resolving at least in the conveying direction, the second measurement position being spaced apart from the first measurement position in the conveying direction,
(iii) a time difference between the detection of the first object edge at the first measurement position and the detection of the first or second object edge detected in step (ii) at the second measurement position is determined,
(iv) a transit time is determined in which the object edge detected in step (ii) moves through a predetermined measurement path of the second optoelectronic sensor extending in the conveying direction,
(v) the object speed at which the conveyed object moves in the conveying direction is determined based on the transit time and a length of the measurement path, and
(vi) the length of the object is determined based on the determined time difference and the determined object speed.

2. The method in accordance with claim 1,
wherein, in step (i), a rear edge of the conveyed object is detected at the first measurement position and/or, in step (ii), a front edge of the conveyed object is detected at the second measurement position.

3. The method in accordance with claim 1,
wherein the determination of the time difference in step (iii) comprises a trigger signal being output by the first optoelectronic sensor to the second optoelectronic sensor on the detection of the first object edge at the first measurement position, said trigger signal initiating an internal clock of the second optoelectronic sensor.

4. The method in accordance with claim 3,
wherein the time difference is determined based on the cycles of the internal clock that have elapsed until the detection of the object edge detected in step (ii) at the second measurement position.

5. The method in accordance with claim 1,
wherein, in step (vi), the length of the object is further determined based on the distance between the first measurement position and the second measurement position.

6. The method in accordance with claim 5,
wherein, for the calibration, an object of a known length is conveyed and the distance between the first measurement position and the second measurement position is determined or adapted based on the known length.

7. The method in accordance with claim 1,
wherein, in step (i), the first object edge is detected at the first measurement position by means of a light barrier.

8. The method in accordance with claim 1,
wherein the object edge to be detected in step (ii) is detected at the second measurement position by means of a line sensor.

9. The method in accordance with claim 1,
wherein position markings of a reference scale, which is separate from the base frame, are detected by means of at least one further optoelectronic sensor, which is fastened together with the first and the second optoelectronic sensor to a base frame of the object conveyor, and are considered in the determination of the length of the object.

10. The method in accordance with claim 9,
wherein the reference scale comprises a bar which extends in the conveying direction, which is composed of a material having a low coefficient of expansion, and to which the position markings are applied.

11. The method in accordance with claim 9,
wherein the reference scale is floatingly supported.

12. A method of measuring objects that are conveyed in a conveying direction by means of an object conveyor, wherein
(a) an object edge of a conveyed object is detected at an inspection position by means of an optoelectronic sensor,
(b) on the detection of the object edge at the inspection position, a trigger signal is output to at least two further optoelectronic sensors that are spatially resolving at least in the conveying direction and that are arranged spaced apart from one another at least transversely to the conveying direction,
(c) on or after the reception of the trigger signal, sensor data of the optoelectronic sensors that are spatially resolving at least in the conveying direction are read out,
(d) respective positions of the object edge are determined based on the read-out sensor data, and
(e) an orientation of the object edge relative to the conveying direction is determined based on the determined positions of the object edge.

13. The method in accordance with claim 12,
wherein, in step (e), the orientation of the object edge relative to the conveying direction is determined by means of a linear regression.

14. The method in accordance with claim 12,
wherein, in step (b), the trigger signal is further output to an optoelectronic sensor that is spatially resolving at least transversely to the conveying direction and that is arranged in the region of a side edge of the conveyed object, wherein the position of the side edge is determined by means of the optoelectronic sensor that is spatially resolving at least transversely to the conveying direction and an orientation and/or a shape of the object is/are determined based on the position of the side edge.

15. The method in accordance with claim 12 , wherein
(i) a first object edge of the conveyed object is detected at a first measurement position by means of a first optoelectronic sensor,
(ii) the first object edge or a second object edge of the conveyed object is detected at a second measurement position by means of a second optoelectronic sensor that is spatially resolving at least in the conveying direction, the second measurement position being spaced apart from the first measurement position in the conveying direction,
(iii) a time difference between the detection of the first object edge at the first measurement position and the detection of the first or second object edge detected in step (ii) at the second measurement position is determined,
(iv) a transit time is determined in which the object edge detected in step (ii) moves through a predetermined measurement path of the second optoelectronic sensor extending in the conveying direction,
(v) the object speed at which the conveyed object moves in the conveying direction is determined based on the transit time and a length of the measurement path, and
(vi) the length of the object is determined based on the determined time difference and the determined object speed.

16. An apparatus for measuring objects that are conveyed in a conveying direction by means of an object conveyor, said apparatus comprising a first optoelectronic sensor, a second optoelectronic sensor that is spatially resolving at least in the conveying direction, and an electronic control device that is in signal connection with the first optoelectronic sensor and the second optoelectronic sensor,
wherein the apparatus is configured to carry out a method of measuring objects that are conveyed in a conveying direction by means of an object conveyor, wherein
(i) a first object edge of a conveyed object is detected at a first measurement position by means of the first optoelectronic sensor,
(ii) the first object edge or a second object edge of the conveyed object is detected at a second measurement position by means of the second optoelectronic sensor that is spatially resolving at least in the conveying direction, the second measurement position being spaced apart from the first measurement position in the conveying direction,
(iii) a time difference between the detection of the first object edge at the first measurement position and the detection of the first or second object edge detected in step (ii) at the second measurement position is determined,
(iv) a transit time is determined in which the object edge detected in step (ii) moves through a predetermined measurement path of the second optoelectronic sensor extending in the conveying direction,
(v) the object speed at which the conveyed object moves in the conveying direction is determined based on the transit time and a length of the measurement path, and
(vi) the length of the object is determined based on the determined time difference and the determined object speed; and/or wherein
(a) an object edge of a conveyed object is detected at an inspection position by means of an optoelectronic sensor,
(b) on the detection of the object edge at the inspection position, a trigger signal is output to at least two further optoelectronic sensors that are spatially resolving at least in the conveying direction and that are arranged spaced apart from one another at least transversely to the conveying direction,
(c) on or after the reception of the trigger signal, sensor data of the optoelectronic sensors that are spatially resolving at least in the conveying direction are read out,
(d) respective positions of the object edge are determined based on the read-out sensor data, and
(e) an orientation of the object edge relative to the conveying direction is determined based on the determined positions of the object edge.

17. The apparatus in accordance with claim 16,
wherein at least one reflector is, with respect to the conveyed object, arranged opposite the first optoelectronic sensor and/or the second optoelectronic sensor at the object conveyor.

18. The apparatus in accordance with claim 16,
wherein the first optoelectronic sensor and the second optoelectronic sensor have respective optical axes that are oriented obliquely upwardly or obliquely downwardly.

19. The apparatus in accordance with claim 16,
wherein the apparatus further comprises:
at least one further optoelectronic sensor that is spatially resolving at least in the conveying direction and that is spaced apart from the second optoelectronic sensor in the conveying direction, and
at least two optoelectronic sensors that are spatially resolving at least transversely to the conveying direction and that are spaced apart from one another transversely to the conveying direction.
